(19) United States
(12) Patent Application Publication
(10) Pub. No.: US 2010/0106904 A1
(43) Pub. Date: Apr. 29, 2010

(54) SHADOW RAID CACHE MEMORY

(75) Inventors: Stuart Allen Berke, Austin, TX (US); Gary Benedict Kotzur, Austin, TX (US)

Correspondence Address: HAYNES AND BOONE, LLP;IP Section, 2323 Victory Avenue, Suite 700, Dallas, TX, 75219, US

(73) Assignee: DELL PRODUCTS L.P., Round Rock, TX (US)

(21) Appl. No.: 12/256,727

(22) Filed: Oct. 23, 2008

(51) Int. Cl. G06F 12/08; G06F 12/00

(52) U.S. Cl. 711/114; 711/118; 711/E12.017; 711/E12.001

(57) ABSTRACT

A shadow cache memory system includes one or more subsystems to provide a processor, couple a main memory module with the processor, assign a portion of the main memory module to be used for cache memory, couple a shadow memory module to the cache memory and couple a battery with the shadow memory module. The shadow cache memory system also includes using a memory controller, to simultaneously write data to the cache memory and the shadow memory module while the memory controller is unaware of writing the data to the shadow memory module.

### BACKGROUND

The present disclosure relates generally to information handling systems, and more particularly to a shadow RAID cache memory system for an information handling system.

As the value and use of information continues to increase, individuals and businesses seek additional ways to process and store information. One option is an information handling system (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

Many IHSs utilize a redundant array of independent disks (RAID) for data storage. Many RAID systems divide and replicate data among multiple hard disk drives or other memory devices, such as dual in-line memory modules (DIMMs). Using a RAID type data storage, an IHS can achieve a higher performance, greater reliability and hold larger data volumes. RAID controllers may run on an input/output processor (IOP), either as a standalone device or integrated within a RAID On Chip (ROC). Because IHS processors are very fast at processing data and hard disk drives are relatively slow in comparison, one feature that is common on these controllers is a write-back cache. A write-back cache accelerates writes from the host by giving the host processor an acknowledgement (ACK) very quickly and posting the write to the drives as drive response allows. An ACK is generally an acknowledgement that the write to the hard disk drive is complete even before the actual write to the hard disk drive is complete. In doing so, the RAID controller accepts responsibility for ensuring the data is protected until it can save the data to the drives. To protect the data on the DIMM during the event of a power loss between the time of the ACK and the time of the actual writing of data to the hard disk drive, RAID controllers generally have a battery backed DIMM that guarantees that the data is protected for approximately 72 hours.

To allow performance saturated processors to regain overhead to be used for other applications, offload technologies, such as TCP Offload Engine (TOE) and RAID controllers were developed. However, today many IHS processors have multiple cores and future IHS processors will likely continue increasing the number of cores in the processors. Therefore, the industry is trying to find new ways to take advantage of this trend. One new technology, involves moving the RAID engine back to the host processor. This is described as hardware (HW)-assisted software (SW) RAID.

In moving the RAID engine back onto the host, to perform a write-back, the host memory needs to have non-volatile memory used for the write-back cache. A problem with this is that DIMMs on the host CPU are much larger than a ROC RAID card's memory. Therefore, to supply a battery back-up to the DIMM would require a battery that can be up to 10 times larger than the ones used on a RAID card. That would add significant cost, power and real-estate to the final solution.

Accordingly, it would be desirable to provide an improved shadow RAID cache memory system absent the disadvantages discussed above.

### SUMMARY

According to one embodiment, a shadow cache memory system includes one or more subsystems to provide a processor, couple a main memory module with the processor, assign a portion of the main memory module to be used for cache memory, couple a shadow memory module to the cache memory and couple a battery with the shadow memory module. The shadow cache memory system also includes using a memory controller, to simultaneously write data to the cache memory and the shadow memory module while the memory controller is unaware of writing the data to the shadow memory module.

### BRIEF DESCRIPTION OF THE DRAWINGS

FIG. 1 illustrates an embodiment of an information handling system (IHS).

FIG. 2 illustrates an embodiment of a prior art redundant array of independent disks (RAID) on chip (ROC) memory system for use on an IHS.

FIG. 3 illustrates an embodiment of a hardware (HW) assisted software (SW) RAID memory system for use on and IHS.

FIG. 4 illustrates an embodiment of a lockstep dual in-line memory module (DIMM).

FIG. 5 illustrates possible battery requirements for embodiments of DIMM type memory.

FIG. 6 illustrates an embodiment of DIMM chip select switching.

FIG. 7 illustrates an embodiment of DIMM data switching.

### DETAILED DESCRIPTION

For purposes of this disclosure, an IHS 100 includes any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an IHS 100 may be a personal computer, a network storage device, or any other suitable device and may vary in size, shape, performance, functionality, and price. The IHS 100 may include random access memory (RAM), one or more processing resources such as a central processing unit (CPU) or hardware or software control logic, read only memory (ROM), and/or other types of nonvolatile memory. Additional components of the IHS 100 may include one or more disk drives, one or more network ports for communicating with external devices as well as various input and output (I/O) devices, such as a keyboard, a mouse, and a video display. The IHS 100 may also include one or more buses operable to transmit communications between the various hardware components.

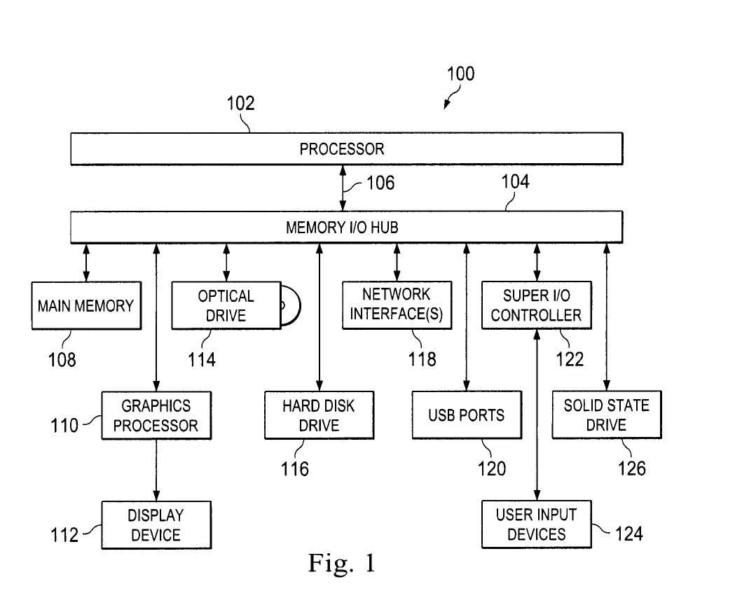

FIG. 1 is a block diagram of one IHS 100. The IHS 100 includes a processor 102 such as an Intel Pentium™ series processor or any other processor available. The processor 102 may have any number of processor cores 103. A memory I/O hub chipset 104 (comprising one or more integrated circuits) connects to processor 102 over a front-side bus 106. Memory I/O hub 104 provides the processor 102 with access to a variety of resources. Main memory 108 connects to memory I/O hub 104 over a memory or data bus. A graphics processor 110 also connects to memory I/O hub 104, allowing the graphics processor to communicate, e.g., with processor 102 and main memory 108. Graphics processor 110, in turn, provides display signals to a display device 112.

Other resources can also be coupled to the system through the memory I/O hub 104 using a data bus, including an optical drive 114 or other removable-media drive, one or more hard disk drives 116, one or more network interfaces 118, one or more Universal Serial Bus (USB) ports 120, and a super I/O controller 122 to provide access to user input devices 124, etc. The IHS 100 may also include a solid state drive (SSDs) 126 in place of, or in addition to main memory 108, the optical drive 114, and/or a hard disk drive 116. It is understood that any or all of the drive devices 114, 116, and 126 may be located locally with the IHS 100, located remotely from the IHS 100, and/or they may be virtual with respect to the IHS 100.

Not all IHSs 100 include each of the components shown in FIG. 1, and other components not shown may exist. Furthermore, some components shown as separate may exist in an integrated package or be integrated in a common integrated circuit with other components, for example, the processor 102 and the memory I/O hub 104 can be combined together. As can be appreciated, many systems are expandable, and include or can include a variety of components, including redundant or parallel resources.

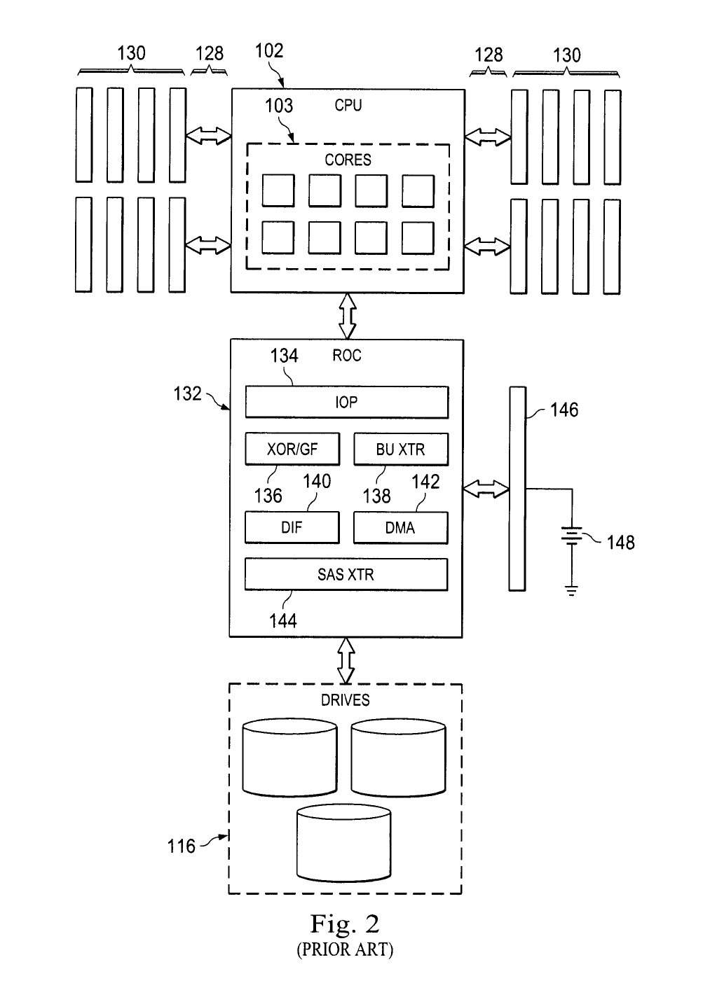

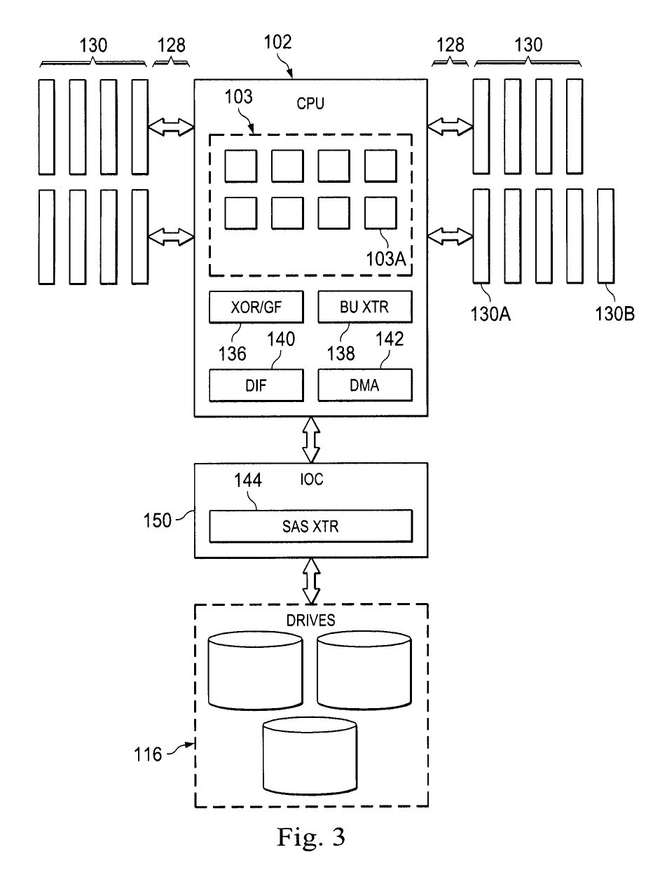

As discussed in the Background section, a hardware (HW)-assisted software (SW) redundant array of independent disks (RAID) system for an IHS 100 involves providing the RAID engine on the host processor 102. This involves moving the RAID engine from the RAID on card (ROC) circuit board to allow the functions of the RAID card to be performed by the processor 102, using system main memory 108 as a cache for virtual memory for the RAID system (see FIG. 3). In moving the RAID engine back onto the host processor 102 from a RAID on Chip (ROC) system (see FIG. 2), to perform a write-back, the host memory (e.g., main memory 108) may have non-volatile memory used for a write-back memory cache to maintain the approximately 72 hour safety time in case of loss of power before the data is written to the hard disk drive 116. However, because memory devices, such as dual in-line memory modules (DIMMs), used with the host processor 102 are generally much larger than standard memory on a ROC RAID card, adequate battery back-up to the DIMM for the acknowledge would require a battery that is too large. Therefore, an embodiment of the present disclosure provides for a smaller DIMM to be added to a RAID system to minimize the impact, while not affecting the overall performance of the final solution.

FIG. 2 illustrates an embodiment of prior art ROC memory system for use on an IHS 100. As shown, the ROC system includes a processor 102 having a plurality of cores 103. Coupled with the processor 102 via a number of data busses 128 are a plurality of memory modules 130. In an embodiment, the memory modules 130 are dual in-line memory modules (DIMMs), but any memory storage devices may be used. A ROC 132 is coupled to the processor 102. As can be seen, the ROC 132 includes the duties of the input/output processor (IOP) 134, the XOR,R5/6, Galios Field multiplier 136, the battery backup unit controller/BU XTR 138, the DIF 140, the direct memory access controller 142 and SAS/SATA XTR controller unit 144. Then, coupled with the ROC 132 is any number of data storage devices, such as the hard disk drives 116. Also coupled with the ROC 132 is a ROC cache memory 146. Providing battery back-up for the cache memory 146 is a battery 148.

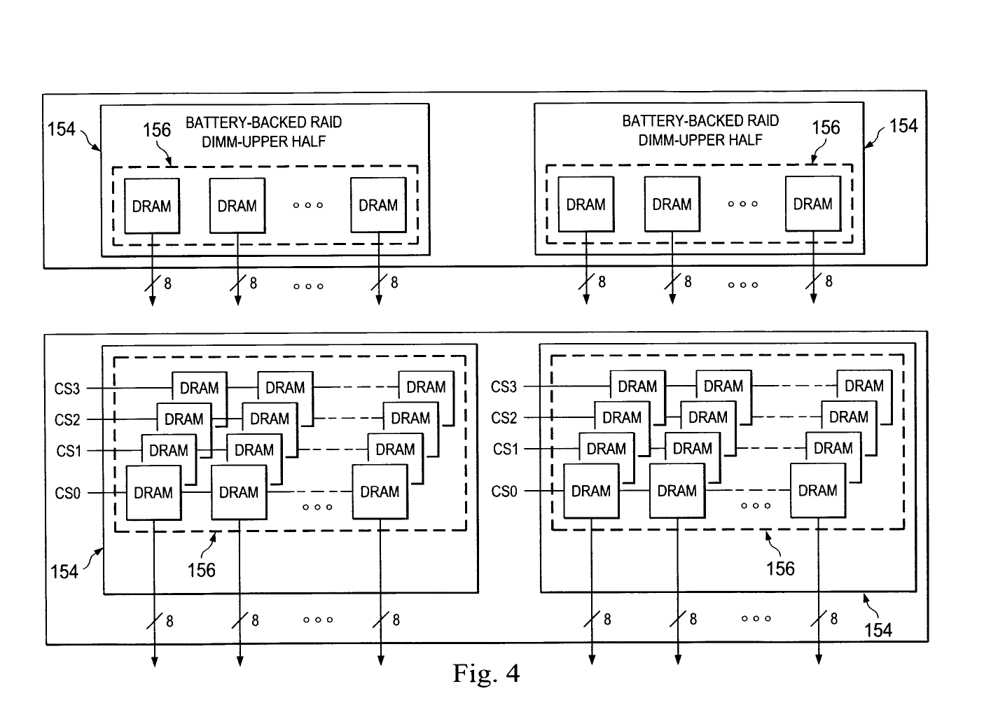

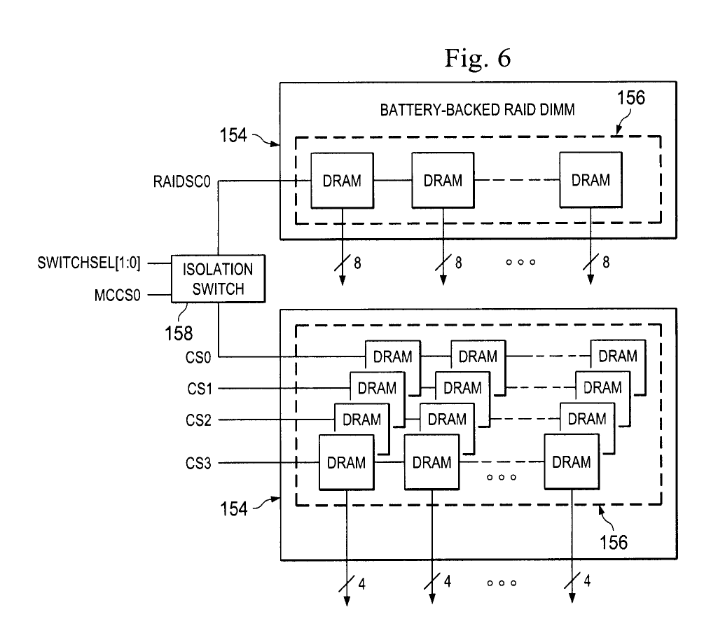

FIG. 3 illustrates an embodiment of a hardware (HW) assisted software (SW) RAID memory system for use on and IHS 100. As can be seen in FIG. 3, the processor 102 includes the duties of the XOR,R5/6, Galios Field multiplier 136, the battery backup unit controller/BU XTR 138, the DIF 140 and the direct memory access controller 142. A south bridge 150 is coupled with the processor 102. Here, the south bridge 150 includes the SAS/SATA XTR controller unit 144. In addition, the processor 102 couples to any number of memory modules130, which may be similar to the DIMM modules 154 shown in FIGS. 4, 6 & 7. Furthermore, one of the memory modules 130A is set aside in the main memory 108 as a RAID cache memory. An additional memory device 130B may be added with a battery back-up for the additional memory device 130B so that all of the memory devices 130 do not need to be battery backed up for approximately 72 hours. A dedicated processor core 103A may be used to process information to and from the additional memory device 130B.

FIG. 4 illustrates an embodiment of a lockstep dual in-line memory module (DIMM). An embodiment of the present disclosure includes adding a dedicated Shadow RAID Cache DIMM (“RAID SIMM”) slot to the provisioned standard server memory DIMM slots. The Shadow RAID Cache DIMM may be operable to write a cached copy of writes (“Snarf”) to a standard DIMM slot. The Shadow Raid Cache DIMM would in general be many times smaller than the DIMM it is shadowing, thereby allowing the system to size the battery backup to a fixed optimal size for the smaller DIMM. For example, the Shadow RAID DIMM may be 1 GB, whereas the standard DIMM it is shadowing may be 4-8 GB based on standard server DIMMs. However, these values may vary. See left side of FIG. 4 as an example. An example of the memory devices used in the DIMM modules 154 is dynamic random access memory (DRAM) memory devices. However, it should be understood that any memory device may be used with the present disclosure.

By adding the Shadow RAID Cache DIMM, worst case battery back-up requirements (DIMM IDD6 Self-Refresh Power) may, in an embodiment, be reduced by a factor of 10-20. For example, a—1 GB SR×8 RAID DIMM using 9×DDR3 1 GB×8 DRAMs=6 mA*9=54 mA vs. Multi-Supplier JEDEC 8 GB QR×4 DRAMs 9 mA*72=648 mA. Thus, this provides a factor of 12x lower IDD. Note that savings may be greater when compared to non-JEDEC standard “hidden rank” DIMMs, which have IDD requirements of 733 mA for 8 GB (13.5× lower) and 1066 mA for 16 GB (19.7× lower).

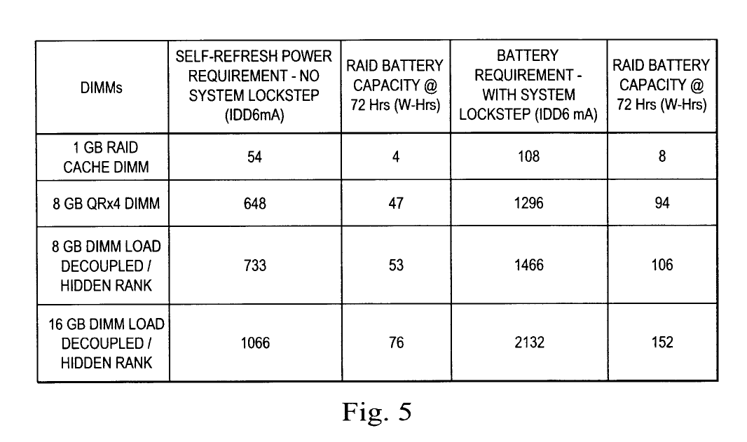

Many mainstream to high-end server IHSs 100 support a memory channel “Lock-Step” mode to support advanced RAS and performance capabilities, where corresponding DIMMs on a pair of DDR channels are accessed simultaneously as a single Logical DIMM. See FIG. 4 for a depiction of Lock Step mode. Unfortunately, this doubles the battery back-up requirements if standard system memory DIMMs are used for the RAID cache memory. In this case, a pair of “Shadow RAID cache DIMMs” may be provided, one for each channel. The same battery power saving factor applies to each channel. However, the worst case battery power capacity requirements are improved by an additional factor of two. See FIG. 5 for a reduction in battery capacity requirements possible with the systems and methods of the present disclosure.

Although the addition of a Shadow RAID Cache DIMM, or DIMM pair for lockstep mode, allows the system to provide a feasible and optimal battery backup solution in terms of cost, volume and etc., there are several implementation impacts to consider. Each of these areas are addressed below along with recommended solutions. It should be noted that alternate embodiments and implementation methods are also possible.

A Chip Select may be shared with the Standard DIMM as shown in FIG. 6. The isolation switch 158 may be implemented in either high speed logic, field effect transistor (FET)-style “Quickswitch” or similar technology. The “SWITCHSEL1:0” control may be system and implementation dependent, and a function of DDR Read/Write, DDR Address Range, and RAID DIMM Select Mode. On Memory Writes, the Isolation switch 158 passes the Chip Select for one of the standard DIMM ranks to both standard DIMM as well as the RAID DIMM. On Memory Reads, the default would be to only pass the chip select to the standard DIMM. RAID DIMM Select Mode is provided to allow reading of the RAID DIMM for special situations, such as, including BIOS memory initialization, memory diagnostics, patrol reading to fix any correctable errors, and to read cache data off the Cache DIMM after a system failure. Reading from the RAID DIMM is not required during normal OS operation. Changing between normal and RAID DIMM Select Mode occurs when the DDR bus is quiescent.

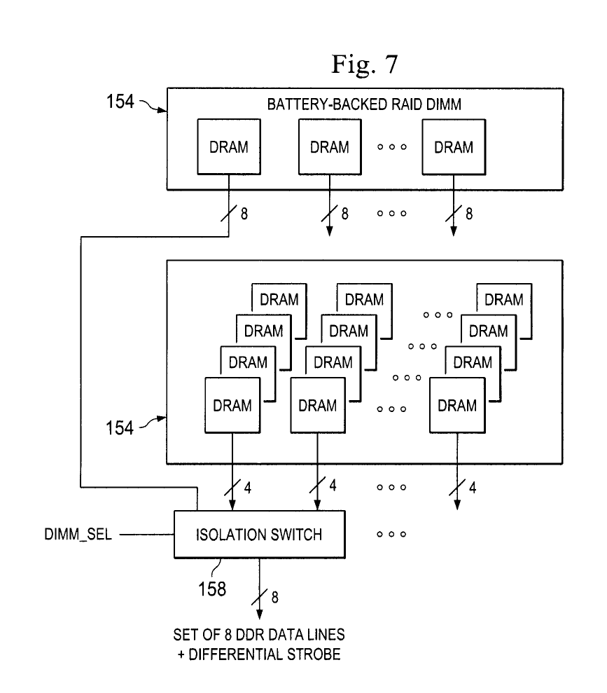

If the addition of the extra Address, Control, and Data loads from the Shadow RAID Cache DIMM impact timing margins or attainable frequencies, several techniques may be employed to maintain desired frequency and performance. In embodiments, these may include addition of high speed buffers on the DDR clock and address and control lines, and using high speed isolation switches/muxes 158 on the data lines as shown in FIG. 7. The isolation switch 158 may make the apparent electrical loading (capacitance, channel) as seen by the system memory controller, be equivalent to topologies in which the extra Shadow RAID Cache DIMM is not included.

The memory controller may be enhanced to directly support the special RAID DIMM, using a standard set of DIMM Control/Status registers, addition of a special RAID Mode Chip Select, addition of special address space for the RAID DIMM, addition of integrated Patrol Scrubbing for RAID DIMM (with ability to manipulate the CS lines appropriately), and/or a variety of other registers. However, even without, an enhanced memory controller architecture, RAID DIMM support is possible. For example, the IHS 100 BIOS may read the RAID DIMM and Standard DIMM SPD EEPROMs, and set up the channel to allow proper composite operation (considering Read/write calibration, UDIMM/RDIMM mixing, ODT settings, and etc.)

In an embodiment, Write Calibration (DDR3/DDR4) includes the following: BIOS executes DDR3/4 Write Leveling and Calibration steps separately to standard DIMM and RAID DIMM, determines valid timing windows, and then selects best settings to ensure writes are valid to both DIMMs. In an embodiment, Read Calibration (DDR2/DDR3/DDR4) includes the following: BIOS executes DDR3/4 RxEn Calibration and DQS Calibration steps separately to standard DIMM and RAID DIMM, determines valid timing windows, and then selects best settings to ensure reads are valid to both DIMMs.

An embodiment of Patrol Scrubbing, is used to flush out any correctable ECC errors in the RAID DIMM, may include the following: BIOS issues a periodic System Management Interrupt to gain control of the system, sets CS to the RAID DIMM, performs a small batch of reads to the cache RAM, and then sets the CS line back to the standard DIMM. In an embodiment, it may also be possible for the RAID driver to coordinate this function.

If the standard DIMMs can reach the physical limit of the memory controller, the RAID DIMM will be read accessed via “Paging/Bank Selection” or “Aliased Address Range”. Because reads are not required during normal operation (except during background patrol scrubbing), this does not effect performance.

Mixed UDIMMs/RDIMMs may be used on the same Channel. Because server memory controllers support both Registered DIMMs (RDIMMs) and Unbuffered DIMMs (UDIMMs), it is possible that the RAID DIMM is one type and the standard DIMMs on the channel are the other type. If the DIMM types are different, the system BIOS would may set up the per DIMM timing to support the worst case combination timing. To minimize extra loading, it is likely the RAID DIMM will be a Registered DIMM.

In Lockstep mode, pairs of DIMMs are accessed as a single logical DIMM (FIG. 4). The RAID DIMM could either be implemented as a double-wide physical SIMM (144 bits of data) to simplify battery backup and DIMM portability, or as two physical “Upper Data” and “Lower Data” DIMMs. A field in the SPD EEPROM could be used to flag Upper/Lower, such that after moving battery backed RAID DIMMs to a new system, the BIOS could determine if the two DIMMs have been swapped and alert the service person to swap them before starting a cache recovery operation.

High end sever IHSs 100 may support numerous memory subsystem RAS features, such as Memory RAS features such as Spare DIMM, Spare Row, Spare Rank, Spare Channel, and Mirroring, to allow the system to operate through and recover from any run-time DIMM or channel error. Spare DIMM/Rank/Row/Channel features allow the system to migrate system memory off of DIMMs and DRAMs that are exhibiting correctable errors, before those memory resources produce fatal errors. With Mirrored memory, the system maintains two copies of system memory divided into Primary DIMMs/Channels and Secondary DIMMs/Channels. When a fatal error occurs on the Primary Mirror, the system will switch/fail over to using the Secondary set. All of the these advanced RAS features add complication to a Shadow RAID Cache DIMM, as the physical DIMMs and channels being used change/migrate during system operation, and the RAID DIMM would need to relocate as well. Note that when Sparing or Mirroring is activated, the system is considered to be in degraded RAS mode, and should be serviced to replace the failed components. Although another battery-backed RAID DIMM could be provisioned on a spare or mirrored channel, it is sufficient to simply flush the RAID Cache DIMM, and then allocate a small portion of system memory for a new RAID cache in write-though cache mode, until the system memory is serviced and the primary DIMMs/Channels are restored.

For a system that supports advanced memory RAS features, such as Spare Row, Spare DIMM, or Mirroring, the RAID DIMM cache may be flushed to the storage subsystem before the system migrates the memory to redundant DIMMS or channels. It is sufficient to simply flush the RAID Cache DIMM, and allocate a small portion of system memory for a new RAID cache in write-through cache mode, until the system memory is serviced.

In summary, an embodiment of the present disclosure provides that a portion of the DIMM modules 154 is used for RAID cache and another DIMM module 154, that is RAID card sized (e.g., approximately 1 GB) that is battery supported is added to provide a battery backed-up cache. Every write from a processor 102 to a memory address in the RAID memory range writes to the original address and the new “extra” or battery backed-up DIMM. The new DIMM is hidden from or otherwise not visible to the operating system under normal operation. Thus, the memory controllers are generally not aware of the shadow, but can be aware in embodiments. As such, the operating system thinks it is writing to the on board DIMMs only, but is actually shadowing or writing to both the DIMMs and therefore makes two copies of the data. Final writes to the media (e.g., the hard disk drive 116) can be from either the on board or shadow DIMM or both, but in normal operation, the RAID controller writes from the on board DIMM. In a power failure situation, the IHS 100 writes the data from shadow DIMM to the original DIMM for the processor 102. Because the operating system is not aware of the shadow DIMM, the system may scrub the shadow DIMM to fix any data errors. An embodiment may use high speed decoding to determine that memory controller is writing to RAID cache memory addresses so that the system may then determine that it needs to write to the shadow DIMM.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A shadow cache memory system comprising one or more subsystems to:
provide a processor;
couple a main memory module with the processor;
assign a portion of the main memory module to be used for cache memory;
couple a shadow memory module to the cache memory;
couple a battery with the shadow memory module; and
using a memory controller, simultaneously write data to the cache memory and the shadow memory module while the memory controller is unaware of writing the data to the shadow memory module.

2. The memory system of claim 1, further comprising a subsystem to:
provide the data written to the shadow memory module to the processor in the event of a power failure to the main memory module.

3. The memory system of claim 1, wherein the main memory module and the shadow memory module are part of a RAID memory system.

4. The memory system of claim 3, wherein the main memory module and the shadow memory module are not part of a RAID-on-chip system.

5. The memory system of claim 1, further comprising a subsystem to:
determine when the data is being written to the cache memory using high speed decoding.

6. The memory system of claim 1, wherein the battery provides at least 72 hours of data retention to the shadow memory module.

7. The memory system of claim 1, wherein the main memory module and the shadow memory module are dual in-line memory modules.

8. An information handling system (IHS) comprising:
a processor; and
a shadow cache memory system coupled to operate on the processor, the memory system comprising one or more subsystems to:
couple a main memory module with the processor;
assign a portion of the main memory module to be used for cache memory;
couple a shadow memory module to the cache memory;
couple a battery with the shadow memory module; and
using a memory controller, simultaneously write data to the cache memory and the shadow memory module while the memory controller is unaware of writing the data to the shadow memory module.

9. The IHS of claim 8, further comprising a subsystem to:
provide the data written to the shadow memory module to the processor in the event of a power failure to the main memory module.

10. The IHS of claim 8, wherein the main memory module and the shadow memory module are part of a RAID memory system.

11. The IHS of claim 10, wherein the main memory module and the shadow memory module are not part of a RAID-on-chip system.

12. The IHS of claim 8, further comprising a subsystem to:
determine when the data is being written to the cache memory using high speed decoding.

13. The IHS of claim 8, wherein the battery provides at least 72 hours of data retention to the shadow memory module.

14. The IHS of claim 8, wherein the main memory module and the shadow memory module are dual in-line memory modules.

15. A method to shadow a cache memory system comprising:
providing a processor;
coupling a main memory module with the processor;
assigning a portion of the main memory module to be used for cache memory;
coupling a shadow memory module to the cache memory;
coupling a battery with the shadow memory module; and
using a memory controller, simultaneously write data to the cache memory and the shadow memory module while the memory controller is unaware of writing the data to the shadow memory module.

16. The method of claim 15, further comprising:
provide the data written to the shadow memory module to the processor in the event of a power failure to the main memory module.

17. The method of claim 15, wherein the main memory module and the shadow memory module are part of a RAID memory system.

18. The method of claim 17, wherein the main memory module and the shadow memory module are not part of a RAID-on-chip system.

19. The method of claim 15, further comprising:
determine when the data is being written to the cache memory using high speed decoding.

20. The method of claim 19, wherein the battery provides at least 72 hours of data retention to the shadow memory module and, wherein the main memory module and the shadow memory module are dual in-line memory modules.
